(19) United States
(12) Patent Application Publication
(10) Pub. No.: US 2012/0054136 A1
(43) Pub. Date: Mar. 1, 2012

(54) System And Method For An Auto-Configurable Architecture For Managing Business Operations Favoring Optimizing Hardware Resources

(75) Inventor: Amitava MAULIK, West Bengal (IN)

(73) Assignee: Connectiva Systems, Inc, New York (US)

(21) Appl. No.: 12/872,470

(22) Filed: Aug. 31, 2010

(51) Int. Cl. G06F 15/18

(52) U.S. Cl. 706/14

(57) ABSTRACT

A system and a method that reduces or optimizes resources, such as computer hardware, of a system used to manage large scale business operations. The system and method provides informed decisions and analysis to address higher risk areas in real time on any occasion, while ensuring overall risk of the business system or systems is maintained below a desired threshold or thresholds. The system and method includes carrying out risk assessment based on trends in decision making and assessing the current risk, such as deciding which aspects of the business is at risk and needs to be monitored closely in real time while other aspects of the business having less risk can be monitored at a slower pace (e.g., in batch mode) using cost-effective resources, without endangering the overall health of the business being monitored.

### BACKGROUND OF THE INVENTION

The invention relates to data processing methods and systems, and more particularly to a method and system of optimizing hardware resources while monitoring transactional/operational data and profile data from a business operation.

In telecommunication, utility and media businesses, for example, information or data (e.g. related to a business process) is often available for collection and processing to enable decision support systems to either directly and automatically make decisions or provide a basis for a person to make a manual decision. It is essential that some decisions be made on current data or information, since situations change. For example, launching a new service typically invites fraudsters who try to get free services by breaking the charging mechanism. Typically a new service needs to be monitored closely until the risks are quantified and controlled. However, decision making in real time requires substantially expensive systems and hardware resources. A delayed response, where the data is processed in batch mode, for example, can significantly reduce resource requirements by scheduling processing during idle hours. However, decisions as to what information or data should be processed in real time and what information or data can be processed later, is not static, and can change depending on emerging situations.

### SUMMARY OF THE INVENTION

In accordance with an embodiment of the present invention, a method of optimizing computer system resources executing a business process is provided. The method comprises applying rules from a set of rules to data related to the business process to locate in real time data deemed critical to the business process and to locate periodically data deemed not critical to the business process; generating alerts and information in real time based on the data deemed critical and alerts and information periodically based on the data deemed not critical. It profiles the information generated in real time and the information generated periodically based on potential risk to the business process. The method decides to notify the business process of risks, based on the alerts and the information generated in real time and the alerts and information generated periodically, notifies in real time if the alerts and the information are generated in real time and notifies periodically if the alerts and information are generated periodically. The method changes the rules from the set of rules applied to the data based on the risks to the business process. In addition, the method can process data related to the business process to a format useable across multiple engines before applying rules. Where the data is deemed critical, it can be defined by one or more thresholds and the alerts can be breaches of one or more thresholds. The information generated comprises summaries of the data and the deciding process can further comprise applying the alerts and the information generated in real time to a decision tree and the alerts and information generated periodically to the decision tree. The rules can be engine independent and can be generated as such. The method can further comprises deploying the changed rules to be applied to either the data in real time or to the data periodically.

In another embodiment of the present invention, a method of optimizing computer system resources executing a business process is provided. This method comprises analyzing data related to the business process in real time based on rules from a set of rules to generate alerts and information in real time on data deemed critical and analyzing data related to the business process periodically based on rules from the set of rules to generate alerts and information periodically on data deemed not critical. It includes profiling the information generated in real time and the information generated periodically based on potential risk to the business process. The method also includes deciding to notify the business process of risks, based on the alerts and the information generated in real time and the alerts and information generated periodically, notifying in real time if the alerts and the information are generated in real time and notifying periodically if the alerts and information are generated periodically. It includes assessing risks of the business process based on the alerts and information generated in real time and generated periodically. Also occurring in the method is the process of changing the rules applied to the data in real time based on the assessed risks to the business process or prioritization of run data processing needs of the business process and changing the rules applied to the data periodically based on the assessed risks to the business process or prioritization of run data processing needs of the business process. The method can further comprise processing data related to the business process to a format useable across multiple engines before applying rules. The data deemed critical can be defined by one or more thresholds and the alerts can be breaches of one or more thresholds. The information generated can comprise summaries of the data and the rules can be engine independent. The deciding process can further comprise applying the alerts and the information generated in real time to a decision tree and the alerts and information generated periodically to the decision tree. The method can further comprise generating rules that are platform independent.

In accordance with another embodiment of the present invention, a computer system for optimizing computer resources executing a business process is provided. The system comprises a first executable component configured to apply rules from a set of rules to data related to the business process to locate in real time data deemed critical to the business process and to locate periodically data deemed not critical to the business process. It has a second executable component configured to generate alerts and information in real time based on the data deemed critical and alerts and information periodically based on the data deemed not critical. A third executable component is provided that is configured to profile the information generated in real time and the information generated periodically based on potential risk to the business process. The system includes a fourth executable component configured to decide to notify the business process of risks, based on the alerts and the information generated in real time and the alerts and information generated periodically, notify in real time if the alerts and the information are generated in real time and notify periodically if the alerts and information are generated periodically. A fifth executable component is included that is configured to change the rules from the set of rules applied to the data based on the risks to the business process. The system can comprise a sixth executable component configured to processes data related to the business process to a format useable across multiple engines before applying rules. The data deemed critical can be defined by one or more thresholds and the alerts can be breaches of one or more thresholds. The information generated can comprise summaries of the data. The fourth executable component can further comprise applying the alerts and the information generated in real time to a decision tree and the alerts and information generated periodically to the decision tree. The rules can be engine independent and the system can comprise a seventh executable component configured to generate rules that are engine independent. The system can further comprise an eighth executable component configured to deploy the changed rules to be applied to either the data in real time or to the data periodically.

### BRIEF DESCRIPTION OF THE DRAWINGS

Further objects, features and advantages of the invention will be become apparent from the following non-limiting exemplary illustrative description of embodiments of the invention with reference to the following accompanying drawings, wherein:

FIG. 1 is an exemplary block diagram that embodies principles of the invention;

FIG. 2 is an exemplary flow chart showing a methodology of information and control flows that embody principles of the invention; and

FIG. 3 is a demonstrative illustration of the manner of hardware optimization achieved by an exemplary system and method for resource optimization in accordance with principles of the invention.

### DETAILED DESCRIPTION OF THE PREFERRED EMBODIMENTS

A system and method is described for data and entity profile capturing, analysis and categorization, for the purpose of balancing processing load across a real time data analysis engine and a batch mode data analysis engine. The system and method can capture data relating to a business process and distinguishes between data that should be processed in real time and data which should be processed periodically, for example, in batch on a commercial database engine, which requires fewer resources and flexible time scheduling. It can generate information including current risk assessments of a business operation based on data from the business operation's process(es) and analysis of such data, where business risks considered risky or high at a particular time are assigned to real time monitoring and current risks assessments considered less risky or low are assigned to periodic monitoring. By continuously balancing distribution, hardware and software resources are optimized. For example, while the system and method is monitoring the business operation's systems and processes for fraudulent activity or identify leakage, any system or process that has undergone recent change in the business operation can be monitored more closely to identify errors, regressions in functionality, fraud attacks, etc.

Generally, the preferred embodiment of the present invention captures data (e.g., batch data) relating to a business process, executes or applies rules (e.g., analysis, business) to match patterns in the data and analyzes the data in real time or during idle time, performs risk assessment of the current data for an ongoing business operation(s) and generates an appropriate alert (e.g., signal, alarm) when a risk threshold (e.g., limit) is breached. Optimizing is based, in part, on related operative data analysis to distinguish between the real time processing needs and processing needs that may take place periodically, in batch, for example, on a commercial database engine.

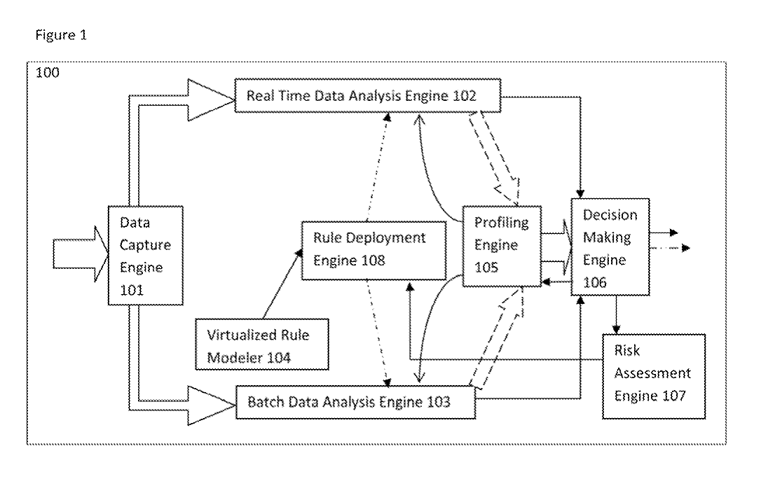

FIG. 1 shows system 100 including software components (101 through 107) deployed on computer hardware, such as one or more computers, in accordance with the preferred embodiment of the present invention. Business operation systems (e.g., production systems) monitored by system 100 can be, for example, those in a revenue chain, like mediation and billing. During post monitoring, system 100 can aid a manager or operator in making decisions at a production site. For example, decisions such as identifying and correcting leakage points, such as incorrect configurations, identifying internal and external fraudulent activities, such as adding balance to prepaid subscribers, and other opportunities to maximize and protect revenue, etc. In the preferred embodiment of the present invention, system 100 includes a data capture engine 101, a real time data analysis engine 102, a batch data analysis engine 103, a virtualized rule modeler 104, a rule deployment engine 108, a profiling engine 105, a decision making engine 106 and a risk assessment engine 107.

Data capture engine 101 collects data from production systems in an organization and prepares the data (e.g. event data records) for analysis by system 100. An event data record can be, for example, the billing record for a telephonic usage of service, capturing who is the subscriber, what service did that subscriber use, when, and for how long. Data capture engine 101 extracts the data from its native format, for example, by parsing, transforming to an internal star schema structure, enriching, and pre-processing. In the preferred embodiment of the present invention, data capture engine 101 processes the data in the following ways:
a) Data is normalized such that dimensional data contains foreign keys and only measures contain numerical values;
b) Field values are converted to a common format based on domain;
c) No duplicates;
d) Partial events are collected into a single event;
e) Data is sequenced and missing sequences are identified.

In the preferred embodiment of the present invention real time data analysis engine 102 is a stream processing engine that receives streams of data from data capture engine 101 and applies rules (e.g, a) through h) discussed below) in real time to the data. Batch data analysis engine 103 receives streams of data from data capture engine 101 and loads the stream data to a relational data base (e.g., embedded database) and then performs the same analyses of the data that real time data analysis engine 102 performs (e.g., a) through h) discussed below) to the data. However, batch data analysis engine 103 applies the rules periodically, in batches, thus saving on hardware and software resources. The data capture engine 101 sends the same data to both analysis engines 102, 103. The rules presently in real time data analysis engine 102 identify the data associated with the rules deemed critical at that time, while the rules in the batch data analysis engine 103 identify the data associated with the rules deemed non-critical at that time. In this exemplary embodiment of the present invention, at the beginning, the workload is evenly distributed across the real time data analysis engine 102 and batch data analysis engine 103. Thus, at the beginning of the process, the distribution of rules in both analysis engines 102, 103 are generally identical. It should be realized that as time progress, system 100 changes the distribution of rules accordingly.

Generally, the rules are designed in virtualized rule modeler 104 and deployed by rule deployment engine 108 (discussed later) from virtualized rule modeler 104 to both the real time data analysis engine 102 and batch data analysis engine 103. In the preferred embodiment of the present invention, the exemplary rules perform the following processes:
a) Filter the data according to certain criteria;
b) Count the filtered records;
c) Bucket the records according to certain dimensions in the data, for example, subscriber, dealer, service;
d) Apply aggregations on the records in a bucket, like count, sum, max, min, etc. This gives the number of events per subscriber, for example. The aggregations on buckets are called counters;
e) Sum the aggregated values in several time based moving windows. For example, this counter gives the number of events per subscriber in a moving window of an hour;
f) Apply thresholds on the counters based on values obtained from profiling engine 105. This allows the setting of subscriber specific thresholds on the number of events per hour. For example, a subscriber who typically makes a lot of phone calls is allowed a higher threshold on hourly call count than someone who rarely makes calls;
g) Provide summary information to profiling engine 105;
h) Provide breach of threshold information to the decision making engine 106.

For example, if a subscriber typically makes 10 calls a day, and has an automatically determined threshold set at 2 calls an hour, suddenly makes 10 calls in one hour, then the amount by which the threshold has been crossed, 500% in this case, is provided to the decision making system.

Virtualized rule modeler 104 allows rules to be specified or designed so they can be executed on both real time data analysis engine 102 or batch data analysis engine 103. The rules are virtualized, such that they are engine independent and thus can be executed or run on either analysis engine 102 or 103 without modification. In the preferred embodiment of the present invention, the rules are created and edited by a user through a graphical user interface that is part of virtualized rule modeler 104, in a one-time process, and maintained within it for deployment. Virtualized rule modeler 104 can also interface with other systems allowing it to import and export rules.

As shown in FIG. 1, profiling engine 105 receives and sends data to and from real time data analysis engine 102, batch data analysis engine 103 and decision making engine 106 (discussed later). In the preferred embodiment of the present invention, profiling engine 105 performs the following exemplary processes:
a) It is separately provided attributes of the entities under observation from production systems. For example, for high usage postpaid telecom fraud, all subscriber information provided during application, such as personal information, demographics, etc. would be available to it;
b) Collects summaries of all usage information being processed by real time data analysis engine 102 and batch data analysis engine 103;
c) Collects all decisions made by decision making engine 106 on individual entities;
d) Applies clustering algorithms to all the entities based on different perspectives to group entities into different segments. For example, it identifies if based on the attributes of a subscriber that subscriber can be classified to fall in one of the known groups of subscribers, or is it an outlier;
d) Quantifies each behavior and multiplies by a weight to obtain a score. For example, the frequency of late bill payments over the last year by a subscriber may be considered as an attribute and this number multiplied by the weight given to this attribute becomes the score for this attribute. This will be done for all such attributes and then summed up to obtain an overall score for the subscriber. The weights themselves will be different based on the segment that the subscriber belongs to, depending on the classification applied in the previous step. In the preferred embodiment, these are all sub-steps and the result data is not sent anywhere. At the end the thresholds are determined for each subscriber and provided to the analysis engines.
e) Performs analyses of behavior trends for individual entities and across multiple entities. Before obtaining a final score on an entity, it is determined whether this entity is relatively unique, or whether this is a common pattern. In case of the latter the score may be decreased since this seems to be common behavior and needs to be normalized accordingly;
f) Determines the appropriate thresholds and tolerances levels for each entity under observation. Each subscriber segment is assigned a threshold based on the risk posed by typical subscribers who belong to that segment. To distinguish among subscribers within a segment, such as those who are near the boundaries, a tolerance is associated to each entity as a further refinement on the thresholds. The lower risk subscribers have higher tolerances than the higher risk subscribers;
g) Periodically revises its scoring parameters and clustering boundaries based on new training data. The training data is collected periodically from logs of analyst actions during scrutiny of a decision made within the external trouble ticketing system that is fed all decisions made within the decision making engine 106. Each decision made by the decision making engine 106 is a ticket in the external trouble ticketing system. The ticket contains information on the decision and the scores provided by the profiling engine, along with all information about the subscriber that is available to the system 100. This information is analyzed by a user before any final action is taken. The user can mark decisions that are incorrect through the Graphical User Interface of the trouble ticketing system. This information is collected and analyzed by profiling engine 105, using data mining technology, to obtain a new refined set of parameters that will enable decisions with fewer errors in the future, provided the type of situation remains unchanged. If the situations change drastically, erroneous decisions may again be made by the system till it is tuned again;
h) Provides all profiling information to decision making engine 106 to allow it to make accurate decisions.
i) Provides the entity specific thresholds and tolerances to the analysis engines 102 and 103;

Generally, decision making engine 106 collects all threshold breaches (e.g., threshold breaches) from analysis engines 102, 103 and profiling information from profiling engine 105. As explained below, the decisions made are either sent to an external trouble ticketing system for human intervention or directly to the business operation system(s) being controlled (e.g., Telecom Billing), to minimize business risk. The decisions are also sent to profiling engine 105 and risk assessment engine 107 (discussed later). An example of a decision made to a billing system of a business operation may be to notify a business user in charge of the billing system to correct a Bill Plan configuration error. The decision may be triggered by batch analysis engine 103 that may determine that there is a large discrepancy in the Bill Amount for subscribers in a certain Bill Plan, when comparing production data against re-billing performed with reference data. If the discrepancy is larger than the threshold obtained from profiling engine 105, an alert would be sent to the decision making engine 105 from batch data analysis engine 103. In the preferred embodiment of the present invention, decision making engine 106 performs the following process:
a) Collects all threshold breaches from real time data analysis engine 102 and batch data analysis engine 103;
b) Collects all profile information from profiling engine 105 on individual entities to understand an entity's likelihood of different types of behavior, for instance, the likelihood that a particular subscriber is committing fraud in a high usage situation;
c) Categorize the fault based on a combination of threshold breaches and profile information;
d) Actually make a decision based on the threshold breach, the profile information, and the fault category. The Decision making engine 106 applies a Decision Tree Algorithm (known in the art) to determine which decision to take and the confidence and support of that decision, based on statistical principles.
e) Feed the profiling engine 105 with new decisions that were taken with or without human intervention so future profiles and predictions are more accurate. The decisions suggested by this engine may be configured to either be directly applied to the systems being controlled, or approved by a human participating in a workflow before any action is taken. The engine may be configured such that decisions that have a confidence above a value set by the administrator are automatically applied, while decisions with lower confidence are approved by the human. The results of these approvals will be fed back to the profiling engine 105 to enable the system to learn from the actions of the human operator;
f) Feed a risk assessment engine 107 all decisions being made;
g) Trigger workflows to involve humans in the decision making process. The decision making engine may be configured to involve humans in the final approval process of the decision, rather than making the final decision itself. This may be configured to be done for all decisions or only those that do not satisfy a certain level of confidence;
h) Take decisions and either display decisions to a user on a computer screen, an email or Text Message. The Decision making engine may also integrate with other enterprise systems using web service integration technology to perform corrective actions specific to each decision, as configured by the administrator.

Risk assessment engine 107 receives decisions from decision making engine 106 and determines trends from the decisions and determines current risk. Risk assessment engine 107 essentially determines which aspects of the business is at risk and needs to be monitored closely in real time. That is, which rules should be applied in real time data analysis engine 102 and which rules should be applied in batch data analysis engine 103. This engine continuously collects all faults and corresponding decisions made by decision making engine 106 against each production system being monitored in the business. At the beginning, the workload is evenly distributed (e.g., same rules applied in both analysis engines 102, 103) across the real time and batch analysis engines by a user, then risk assessment engine 107 collects information and determines trends in the fault occurrence over time. After monitoring over time, risk assessment engine 107 determines trends that predict faults in certain data sources. For example, during holiday season, a text messaging service can get overloaded and lead to high discrepancy. Risk assessment engine 107 determines trends from decision data sent to it from decision making engine 106 and determines which rules and data sources should be processed in real time and which should be processed in batch. As time progresses and more historical data becomes available to system 100, the risk assessment engine 107 becomes more accurate in predicting faults. The assessment made by risk assessment engine 107 is fed to the rule deployment engine 108, as shown in FIG. 1.

Rule deployment engine 108 receives risk assessments from risk assessment engine 107 and activates virtualized rules either in the real time data analysis engine 102 or in the batch data analysis engine 103 based on the current risk assessment determined by risk assessment engine 107. The specific rule activated in one engine is deactivated in the other engine. (At the start, all rules are deployed on both engines and activated as per a default strategy.) If a particular aspect of the business is determined by the risk assessment engine 107 to be a high risk and needs to be monitored immediately, the corresponding rule associated with that risk is activated in the real time data analysis engine 102, and deactivated on the batch analysis engine 103, to limit the risk exposure to the business. Similarly, if the risk of a certain aspect of the business is determined by risk assessment engine 107 to be low, then all rules associated with that risk are activated on the batch data analysis engine 103, and deactivated on the real time analysis engine 102.

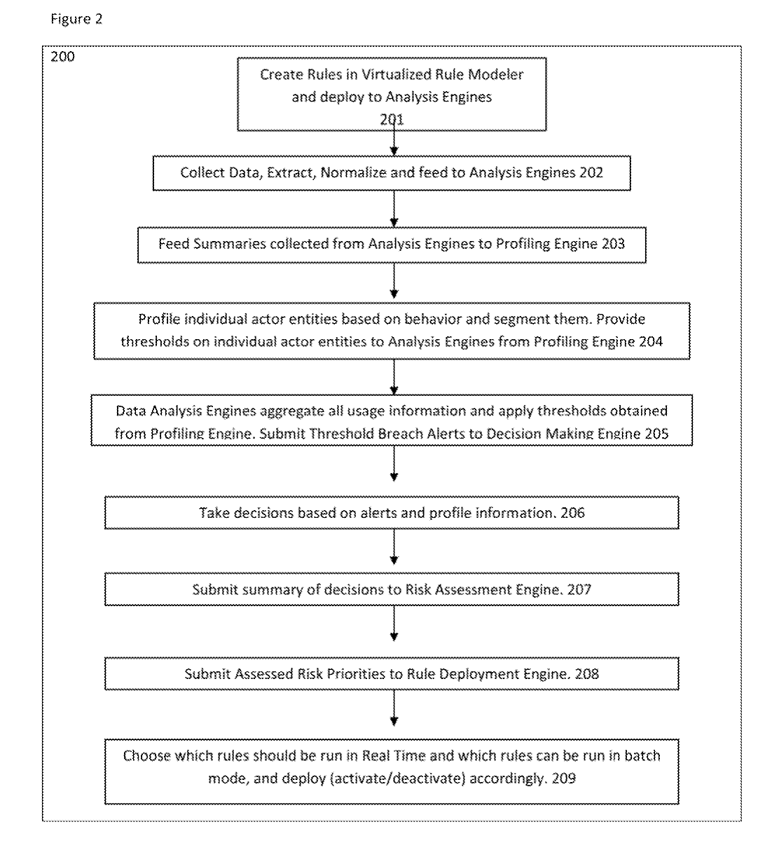

FIG. 2 illustrates a method for optimizing hardware and monitoring all transactions of a large business, for example a telecommunications, utility, or media business, etc, in accordance with the preferred embodiment of the invention. The method balances the load (i.e., data load) across a real time engine and a batch mode engine, resulting in a reduction of hardware or processing requirements while ensuring that an overall risk in a business is kept below a desired threshold.

Referring to FIG. 2, at block 201, rules (i.e., virtualized rules) are created by a user (e.g., operator) using virtualized rule modeler 104, by way of a graphical user interface. Virtualized rule modeler 104 allows the specification of rules without any indication of which engine the rules will be executed or run. The rules are therefore virtualized over the engines. Virtualized rules may be executed on either real time analysis engine 102 or batch data analysis engine 103, based on a current risk assessed by risk assessment engine 107. However, in the preferred embodiment of the present invention, initially, while the risk assessment engine is being set up (e.g., learning), the operator can manually distribute the rule executions across analysis engines 102 and 103. As explained earlier, all rules are deployed on both engines and each rule is active for execution on exactly one of the two engines (real time data analysis engine 102 or batch data analysis engine 103).

At block 202, data capture engine 101 collects, extracts, and normalizes data before feeding the data to real time analysis engine 102 and batch data analysis engine 103 for processing. In the preferred embodiment of the present invention, data capture engine 101 collects transactional and dimensional data from various business systems, such as network elements, Mediation, Billing, Interconnect, within an organization. As mentioned above, this data is extracted from its native format, normalized to a format that can be easily analyzed across multiple data sources, and then fed to both real time analysis engine 102 and batch data analysis engine 103 for processing.

Real time analysis engine 102 and batch data analysis engine 103 process the data, create summaries on usage, and feed this information to profiling engine 105, at block 203. Generally, the summaries are computed by counting the number of a certain type of usage record after grouping it by an entity. For example the number of outgoing international calls made by a subscriber within an hour.

At block 204, the summaries computed in the real time engine 102 and batch analysis engine 103 for individual actor entities (who have generated usage events) are fed to the profiling engine 105, which profiles them based on their behavior and classifies them in particular segments. An actor entity is that which has generated the event and is under study. Specifically, in the preferred embodiment of the present invention, profiling engine 105 applies profiling algorithms (known in the art) to types of individual actor entities (e.g., customers, dealers, employees, vendors, partners, processes, systems) associated with the business being monitored, which are deemed suitable by the business user for analysis due to their potential risk impact to the business. In this example, demographics and behavior of these entities are analyzed to segment these actors into risk categories to which thresholds are assigned. The thresholds are initially assigned by the business user and after enough historical information has been collected, data mining algorithms known in art may be used to tune the thresholds for higher accuracy of the system. For actors who are found to be scarce in quantity, special risk thresholds may be assigned. These thresholds are made available to real time data analysis engine 102 and batch data analysis engine 103 to allow them to quickly identify transactions that need to be analyzed further for potential risk mitigation actions.

In the preferred embodiment of the present invention, real time data analysis engine 102 and batch data analysis engine 103 aggregate all usage information and apply thresholds obtained from profiling engine 105, then submit threshold breach alerts to decision making engine 106, at block 205. Specifically, real time data analysis engine 102 and batch data analysis engine 103 process all transactions and attribute information on the actor entities and collect enough aggregate information to enable decision making.

For example, the usage pattern of a user may be studied to understand how frequently a specific user makes calls to a destination that is associated with unlawful activities. The threshold values per group and per subscriber, obtained from profiling engine 105, enable the data analysis engines to provide alerts when thresholds are breached, but with minimal scope for false alerts. In another example, if a subscriber is known to be a detective who is investigating a particular unlawful activity, calls by the subscriber to a hot-listed number should not raise alerts. One suitable way for eliminating false alerts is for profiling engine 105 to determine the true nature of the investigator and to assign a high threshold to that subscriber. For all other subscribers typically the threshold for calling a hot-listed number will be low, for example, 1. Any breach of this threshold will raise an alert to decision making engine 106 (205).

At block 206, decision making engine 106 makes decisions based on alerts and profile information. In the preferred embodiment of the present invention, decision making engine 106 captures all alerts and makes appropriate decisions to mitigate risks. This is achieved by collecting all profile information on the actor from profiling engine 105 along with the alerts on this actor in the specific context of the alert. If, for example, based on the demographics and the actor's actions that have breached thresholds, the actor is deemed to be posing a risk to the organization, then a decision may be suggested by decision making engine 106 to take action against that actor. Possible actions may be barring services to a customer/subscriber, terminating the contract of a dealer, and/or applying a penalty to a vendor, etc. These suggestive actions may be fed from decision making engine 106 to business systems, such as a trouble ticketing system or another platform, as deemed appropriate by the business.

At block 207, decision making engine 106 computes summaries on the decisions it makes, categorizes them, and feeds them to risk assessment engine 107. Risk assessment engine 107 determines trends in decision making and assesses the current risk of the complete business system being monitored. The information analyzed is current information, historical information, alerts, resolutions, areas that have not raised alerts ever, areas that raise sporadic errors, chronic errors, malicious errors, newly introduced rules that need close monitoring, etc. Decision making engine 106 determines the risk associated with different operational areas. Risk assessment engine 107 also estimates which areas will benefit most from immediate attention. For example, if it is predicted that during holiday season text messaging system has errors, system 100 may decide, based on the calendar that the data from the text messaging system and the corresponding rules be executed on the real time analysis engine during the holiday season. Based on the analysis, at block 208, risk assessment engine 107 submits assessed risk priorities to rule deployment engine 108. In the preferred embodiment of the present invention, risk assessment engine 107 computes the priorities of the rules and informs rule deployment engine 108.

For example, a new rate plan is launched at a Telecom Operator. Risk assessment engine 107 captures that information from the age of the rate plan and prioritizes all rating assurance rules for real time analysis until there is a certain degree of confidence in the accuracy of the risk assessment engine 107 configuration. After that, the prioritization should be lowered. In another example, there could be an addition of a new Interconnect partner. Rules that check Interconnect invoices should be given higher priority to ensure that any errors during configuring rules for this partner are captured as early as possible to minimize revenue leakage. Similarly, with fraud, if a certain new service is launched, the fraud rules associated with data sources that contain information on using that service should be given higher priority for a certain period. It is also possible that a certain type of fraud, such as Premium Rate Service Fraud, is suddenly being observed and necessitates that the real time analysis engine immediately analyzes the data for that type of fraud.

As mentioned above, rule deployment engine 108 obtains the risk associated with each rule from risk assessment engine 107 and activates the rule on the appropriate engine, either real time data analysis engine 102 or batch data analysis engine 103.

If a rule's priority is high, this typically means that risk assessment engine 107 has determined that the priority of this rule being satisfied is high, and the potential loss that will be incurred if this rule is satisfied is very high. In addition the loss is cumulative over time, implying that late action will linearly or non-linearly increase the amount of revenue loss. In such situations, it is imperative that system 100 process this rule on data as soon as it arrives in system 100, in real time, and decisions are made in real time.

Real time may imply either during the time an event is occurring, or immediately after an event has occurred. Such rules should be deployed on real time data analysis engine 102.

If a rule's priority is less, this typically implies that risk assessment engine 107 has determined that there is a low probability of that rule being satisfied, and also the loss incurred when that rule is satisfied is low. In addition, the loss may not increase over time, or even if it does, it is at a very low rate. Under these conditions it is not necessary to process the rule in real time, and periodic checks of the conditions with hourly, daily, weekly, monthly periodicities may be sufficient. Such rules should be deployed on batch data analysis engine 103.

At block 209, rule deployment engine 108 chooses which rules should be run in real time and which rules can be run in batch mode based on information received from risk assessment engine 107, and activates the rules on the appropriate engine accordingly. As an example of high priority processing, after activation on the real time data analysis engine 102, the virtualized rule is automatically executed by the real time data analysis engine 102 on the data source it is associated with. As soon as the rule is deployed and data is available to it, alerts will be generated if the conditions specified in the rule are satisfied, enabling decisions to be taken in the shortest possible time.

In the preferred embodiment of the present invention, if, at block 209, a rule does not need immediate processing, the virtualized rule will be obtained from virtualized rule modeler 104 and will be activated on batch data analysis engine 103. After activation, the virtualized rule is automatically executed on the data source it is associated with. After arrival of the data, batch data analysis engine 103 may not apply the rule immediately, but will process it periodically, as per the risk assessment of the rule.

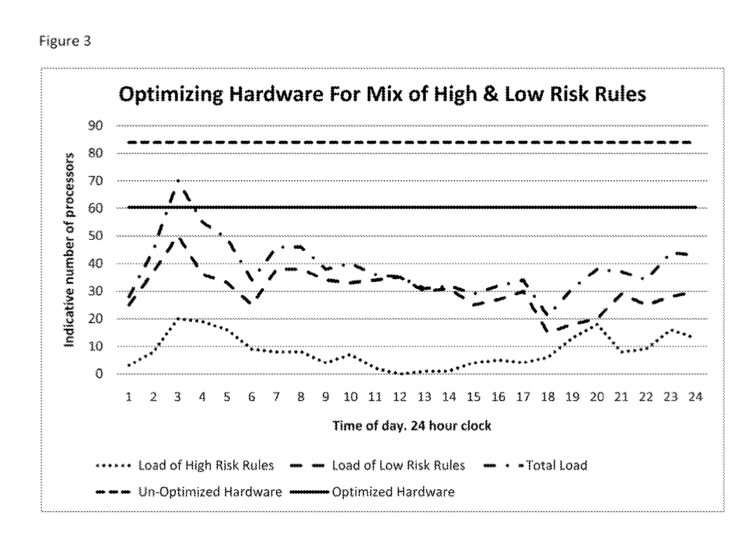

FIG. 3 shows an example of a one day processing load and how hardware can be optimized while at the same time the responsiveness of the system according to the present invention can be maintained at real time. The graph shows hourly values of the number of hardware resources demanded by various rules.

The first graph “Load of High Risk Rules” shows the resource demands of the High Risk Rules. These rules require enough hardware to process peak loads so that at times of peak load the time taken to respond to an event remains the same as during off peak loads. Hence the hardware demand for real time processing is directly proportional to the maximum expected peak load.

The next graph shows the “Load of Low Risk Rules”. Typically, there are more such rules than the High Risk Rules. Since these rules do not need immediate attention, these may be processed in batch and the hardware requirements for these rules is the average value of all the loads demanded by these rules.

The next graph shows the sum of all the rules and named “Total Load”. The next horizontal line graph “Un-Optimized Hardware” shows the hardware requirement if all rules were processed in real time. This achieves real time performance of High Risk Rules, which is desirable, but also achieves real time performance of low risk rules, at the cost of high cost of hardware. The optimized hardware proposed here achieves significant reduction in hardware and at the same time it satisfies the responsiveness requirement of the system. This is shown in the horizontal line graph “Optimized Hardware”. Processing all rules in batch would require even less hardware, but this fails to respond to High Risk Rules in real time, is therefore undesirable and not shown here.

The key challenge addressed here is that the High Risk Rules are not known a priori and can keep changing as real life events affect the system being monitored. Predicting future risks and having virtualized rules that can be deployed on different environments in unattended mode ensures that hardware is used optimally. In actual scenarios, a buffer will be provided in case the predicted future requirements are more than what is observed historically. When the buffer amount will be predicted to be exceeded, the Decision Making Engine 106 will notify the appropriate departments to provide more hardware to the system, perhaps provisioning from a cloud.

It is thus possible to provide data processing for near real time decision making which would be less expensive in terms of hardware resources by way of advantageously optimizing the available and required resources utilized by various operators, such as when monitoring all transactions of a large operator in telecom, utilities, media, etc. The decision making facilities can be applied for application in revenue assurance, fraud management, revenue maximization, and customer analytics. Identifying the processing needs that need not be in real time, and may take place in batch on a commercial database engine requiring fewer resources provides for the required processing to be run in real time, or in batch, depending on the current risk perception. Anything that is considered more risky at a particular time should be run in real time, and those that are considered less risky may be run in batch. By continuously balancing this distribution, the resource requirements for such activity may be optimized.

The processes, flowchart and methods described can be implemented in a wide variety of environments. For example, any of the disclosed techniques can be implemented in whole or in part in software comprising computer-executable instructions stored on tangible computer-readable media (e.g., tangible computer-readable media, such as one or more CDs, volatile memory components (such as DRAM or SRAM), or nonvolatile memory components (such as hard drives)).

The processes, flowcharts and methods described can be executed on a single computer or on a networked computer (e.g., via the Internet, a wide-area network, a local-area network, a client-server network, or other such network). Any of the disclosed processes, flowchart and methods can alternatively be implemented (partially or completely) in hardware (e.g., an ASIC, FPGA, PLD, or SoC).

Further, data produced from any of the disclosed processes, flowchart and methods described can be created, updated, or stored on tangible computer-readable media (e.g., tangible computer-readable media, such as one or more CDs, volatile memory components (such as DRAM or SRAM), or nonvolatile memory components (such as hard drives)) using a variety of different data structures or formats. Such data can be created or updated at a local computer or over a network (e.g., by a server computer).

What is claimed is:

1. A method of optimizing computer system resources executing a business process, comprising:
applying rules from a set of rules to data related to the business process to locate in real time data deemed critical to the business process and to locate periodically data deemed not critical to the business process;
generating alerts and information in real time based on the data deemed critical and alerts and information periodically based on the data deemed not critical;
profiling the information generated in real time and the information generated periodically based on potential risk to the business process;
deciding to notify the business process of risks, based on the alerts and the information generated in real time and the alerts and information generated periodically, notifying in real time if the alerts and the information are generated in real time and notifying periodically if the alerts and information are generated periodically; and
changing the rules from the set of rules applied to the data based on the risks to the business process.

2. The method of claim 1 further comprising processing data related to the business process to a format useable across multiple engines before applying rules.

3. The method of claim 1, wherein the data deemed critical is defined by one or more thresholds.

4. The method of claim 1, wherein the alerts are breaches of one or more thresholds.

5. The method of claim 1, wherein the information generated comprises summaries of the data.

6. The method of claim 1 wherein the deciding process further comprises applying the alerts and the information generated in real time to a decision tree and the alerts and information generated periodically to the decision tree.

7. The method of claim 1 wherein the rules are engine independent.

8. The method of claim 1 further comprising generating rules that are engine independent.

9. The method of claim 1 further comprising deploying the changed rules to be applied to either the data in real time or to the data periodically.

10. A method of optimizing computer system resources executing a business process, comprising:
analyzing data related to the business process in real time based on rules from a set of rules to generate alerts and information in real time on data deemed critical;
analyzing data related to the business process periodically based on rules from the set of rules to generate alerts and information periodically on data deemed not critical;
profiling the information generated in real time and the information generated periodically based on potential risk to the business process;
deciding to notify the business process of risks, based on the alerts and the information generated in real time and the alerts and information generated periodically, notifying in real time if the alerts and the information are generated in real time and notifying periodically if the alerts and information are generated periodically;
assessing risks of the business process based on the alerts and information generated in real time and generated periodically;
changing the rules applied to the data in real time based on the assessed risks to the business process or prioritization of run data processing needs of the business process; and
changing the rules applied to the data periodically based on the assessed risks to the business process or prioritization of run data processing needs of the business process.

11. The method of claim 10 further comprising processing data related to the business process to a format useable across multiple engines before applying rules.

12. The method of claim 10, wherein the data deemed critical is defined by one or more thresholds.

13. The method of claim 10, wherein the alerts are breaches of one or more thresholds.

14. The method of claim 10, wherein the information generated comprises summaries of the data.

15. The method of claim 10 wherein the deciding process further comprises applying the alerts and the information generated in real time to a decision tree and the alerts and information generated periodically to the decision tree.

16. The method of claim 10 wherein the rules are engine independent.

17. The method of claim 10 further comprising generating rules that are platform independent.

18. A computer system for optimizing computer resources executing a business process, comprising:
a first executable component, the first executable component configured to apply rules from a set of rules to data related to the business process to locate in real time data deemed critical to the business process and to locate periodically data deemed not critical to the business process;
a second executable component, the second executable component configured to generate alerts and information in real time based on the data deemed critical and alerts and information periodically based on the data deemed not critical;
a third executable component, the third executable component configured to profile the information generated in real time and the information generated periodically based on potential risk to the business process;
a fourth executable component, the fourth executable component configured to decide to notify the business process of risks, based on the alerts and the information generated in real time and the alerts and information generated periodically, notify in real time if the alerts and the information are generated in real time and notify periodically if the alerts and information are generated periodically; and
a fifth executable component, the fifth executable component configured to change the rules from the set of rules applied to the data based on the risks to the business process.

19. The system of claim 18 further comprising a sixth executable component, the executable component configured to processes data related to the business process to a format useable across multiple engines before applying rules.

20. The system of claim 18, wherein the data deemed critical is defined by one or more thresholds.

21. The system of claim 18, wherein the alerts are breaches of one or more thresholds.

22. The system of claim 18, wherein the information generated comprises summaries of the data.

23. The system of claim 18 wherein the fourth executable component further comprises applying the alerts and the information generated in real time to a decision tree and the alerts and information generated periodically to the decision tree.

24. The system of claim 18 wherein the rules are engine independent.

25. The system of claim 18 further comprising a seventh executable component, the seventh executable component configured to generate rules that are engine independent.

26. The system of claim 18 further comprising an eighth executable component, the eighth executable component configured to deploy the changed rules to be applied to either the data in real time or to the data periodically.
